(19) United States
(12) Patent Application Publication
(10) Pub. No.: US 2025/0021618 A1
(43) Pub. Date: Jan. 16, 2025

(54) DISTRIBUTED MATRIX MULTIPLICATION OPERATION METHOD AND APPARATUS BASED ON FRAME QUANTIZATION

(71) Applicant: SEOUL NATIONAL UNIVERSITY R&DB FOUNDATION, Seoul (KR)

(72) Inventors: Wan CHOI, Seoul (KR); Kyung Rak SON, Seoul (KR)

(21) Appl. No.: 17/796,009

(22) PCT Filed: Nov. 24, 2021
(86) PCT No.: PCT/KR2021/017368

§ 371 Date: Jun. 12, 2024

(30) Foreign Application Priority Data
Nov. 18, 2021 (KR) 10-2021-0159700

(51) Int. Cl. G06F 17/16

(52) U.S. Cl. CPC G06F 17/16

(57) ABSTRACT

Disclosed are a distributed matrix multiplication operation method and apparatus based on frame quantization, and a method and apparatus for performing distributed matrix multiplication operation in a plurality of computing nodes using coded computing based on frame quantization. In this way, high-dimensional matrix multiplication processing performance is improved.

### BACKGROUND OF THE INVENTION

### Field of the Invention

The present invention relates to a distributed matrix multiplication operation method and apparatus based on frame quantization, and to a method and apparatus for performing distributed matrix multiplication operation in a plurality of computing nodes using coded computing based on frame quantization.

### Description of the Related Art

Content to be described below is merely for the purpose of providing background information related to embodiments of the present invention, and it is obvious that the content to be described is not included in the related art.

High-dimensional matrix operation is essential to enable high-intelligence applications such as big data analysis, augmented reality, and tactile communication that require the intelligence of networks (or specifically, the Internet of Things) in real life.

Since it takes a long time to perform such a high-load operation on a single device, research on distributed computing has been actively conducted to improve performance by distributing and dividing the operation into a plurality of edge devices to perform communication. Distributed computing is presented as one representative keyword of 6G.

Matrix multiplication operation using distributed computing has limitations in terms of operation and communication load congestion, operation speed, and accuracy in a process of allocating operations to respective nodes and receiving operation results.

There is a need for a method capable of efficiently performing high-dimensional matrix multiplication in a distributed computing environment.

On the other hand, the aforementioned related art is technical information possessed by the inventor for the derivation of the present invention or acquired during the derivation of the present invention, and cannot necessarily be said to be known technology disclosed to the general public prior to the filing of the present invention.

### SUMMARY OF THE INVENTION

Therefore, the present invention has been made in view of the above problems, and it is an object of the present invention to provide a distributed matrix multiplication operation method and apparatus capable of distributing and efficiently performing high-dimensional matrix multiplication.

It is another object of the present invention to provide a distributed matrix multiplication operation method and apparatus capable of restoring an original matrix multiplication operation result using a partial encoding matrix multiplication operation result.

The objects of the present invention are not limited to the above-mentioned problems, and other objects and advantages of the present invention that are not mentioned may be understood by the following description, and will be more clearly understood by the embodiments of the present invention. Further, it is to be appreciated that the objects and advantages of the present invention may be realized by means indicated in the claims and combinations thereof.

In accordance with an aspect of the present invention, the above and other objects can be accomplished by the provision of a distributed matrix multiplication operation method including generating a plurality of first submatrices obtained by dividing a first input matrix and a plurality of second submatrices obtained by dividing a second input matrix, generating a first encoding matrix and a second encoding matrix for each computing node of a plurality of computing nodes by encoding each of the plurality of first submatrices and the plurality of second submatrices, distributing the first encoding matrix and the second encoding matrix for each computing node to each computing node, acquiring at least one encoding matrix multiplication result based on the first encoding matrix and the second encoding matrix for each computing node from at least some of the plurality of computing nodes, and restoring a matrix multiplication result for the first input matrix and the second input matrix based on the at least one encoding matrix multiplication result.

In accordance with another aspect of the present invention, there is provided a distributed matrix multiplication operation apparatus including a memory configured to store at least one command, and a processor, in which, when the at least one command is executed by the processor, the at least one command is configured to cause the processor to generate a plurality of first submatrices obtained by dividing a first input matrix and a plurality of second submatrices obtained by dividing a second input matrix, generate a first encoding matrix and a second encoding matrix for each computing node of a plurality of computing nodes by encoding each of the plurality of first submatrices and the plurality of second submatrices, distribute the first encoding matrix and the second encoding matrix for each computing node to each computing node, acquire at least one encoding matrix multiplication result based on the first encoding matrix and the second encoding matrix for each computing node from at least some of the plurality of computing nodes, and restore a matrix multiplication result for the first input matrix and the second input matrix based on the at least one encoding matrix multiplication result.

Other aspects, features, and advantages other than those described above will become apparent from the following drawings, claims, and detailed description of the invention.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an illustrative diagram of a distributed matrix multiplication operation environment according to an embodiment;

FIG. 2 is a block diagram of a distributed matrix multiplication operation apparatus according to an embodiment;

FIG. 3 is a flowchart of a distributed matrix multiplication operation method according to an embodiment;

FIG. 4 illustrates an illustrative encoding frame set;

FIG. 5 is a diagram for illustratively describing a process in decoding for a distributed matrix multiplication operation according to an embodiment; and

FIG. 6 is a graph illustrating an average error probability according to the number of nodes according to an embodiment.

### DETAILED DESCRIPTION OF THE INVENTION

Hereinafter, the present invention will be described in more detail with reference to the drawings. The present invention may be embodied in various different forms, and is not limited to the embodiments described herein. In the following embodiments, parts not directly related to the description are omitted in order to clearly describe the present invention. However, in implementing the apparatus or system to which the idea of the present invention is applied, this does not mean that the omitted configuration is unnecessary. In addition, the same reference numerals are used throughout the specification to refer to the same or similar components.

Terms such as first, second, etc. may be used to describe various components. However, the components should not be limited by the terms. The above terms are used only for the purpose of distinguishing one component from another. In addition, in the following description, a singular expression includes a plural expression unless the context clearly dictates otherwise.

In the following description, it should be understood that a term such as “include” or “have” is intended to designate that a feature, number, step, operation, component, part, or a combination thereof described in the specification is present, and does preclude the possibility of the presence or addition of one or more other features, numbers, steps, operations, components, parts, or combinations thereof.

Encoding computing is a method of allocating additional operations to restore an original operation without receiving operation results from all nodes in order to solve a congestion phenomenon of operation accuracy, speed, operation and communication load, etc. when allocating an operation to each node and receiving an operation result in distributed computing.

Coded computing is a computing method based on coding theory. In distributed matrix multiplication using encoding computing, the performance of the entire system, that is, the operation speed, accuracy, and load of the entire system may vary depending on the method of encoding divided matrices in each edge device.

For example, it has been known that when two matrices to be multiplied are divided into an m×p-submatrix and a p×n-submatrix, respectively, the original desired matrix operation can be restored if there are at least pmn+p−1 edge devices (see Q. Yu, M. A. Maddah-Ali, and A. S. Avestimehr, “Straggler mitigation in distributed matrix multiplication: Fundamental limits and optimal coding,” IEEE Transactions on Information Theory, vol. 66, no. 3, pp. 1920-1933, 2020).

The present invention proposes a distributed matrix multiplication operation method and apparatus using an encoding computing method based on frame quantization theory. According to the embodiments of the present invention, it is possible to perform a distributed matrix multiplication operation that ensures an error rate below a certain level even in an environment where the number of nodes is significantly small.

Hereinafter, the present invention will be described in detail with reference to the drawings.

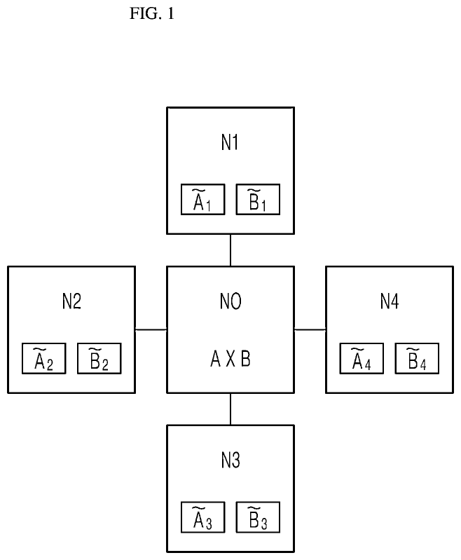

FIG. 1 is an illustrative diagram of a distributed matrix multiplication operation environment according to an embodiment.

A distributed matrix multiplication operation according to the embodiment may be executed in a distributed processing environment including a plurality of computing nodes N1, N2, N3, and N4. The distributed processing environment may include a central node N0 that controls distributed processing. For example, the central node N0 may be one of the plurality of computing nodes N1, N2, N3, and N4 or a separate node.

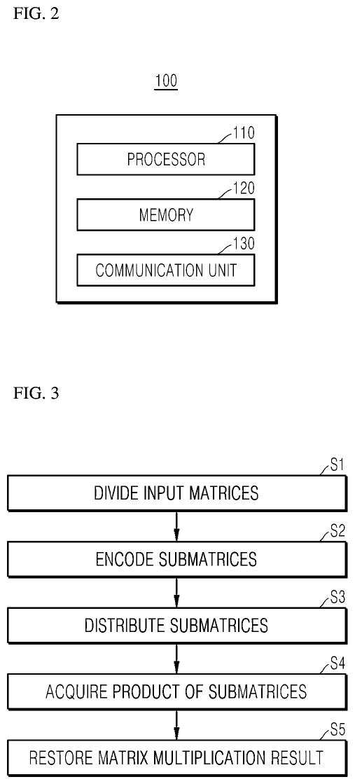

Each of the central node N0 and the plurality of computing nodes N1, N2, N3, and N4 is an example of a distributed matrix multiplication operation apparatus 100 to be described later with reference to FIG. 2. Even though FIG. 1 illustrates four computing nodes N1, N2, N3, and N4, this is an example, and the distributed processing environment may include fewer or more computing nodes.

The central node N0 may distribute a distributed matrix multiplication operation to the plurality of computing nodes N1, N2, N3, and N4, receive operation results from the plurality of computing nodes N1, N2, N3, and N4, synthesize the operation results, and provide a result of the matrix multiplication operation.

In an example, the central node N0 may receive operation results from at least some of the plurality of computing nodes N1, N2, N3, and N4, and generate a result of the matrix multiplication operation therefrom.

The central node N0 may divide an input matrix into a plurality of submatrices in order to perform matrix multiplication between two or more input matrices. The central node N0 may encode the input matrix based on the plurality of submatrices obtained by dividing the input matrix.

In an example, the central node N0 may encode an input matrix using a linear function (linear mapping) for mapping the input matrix to a linear sum of a plurality of submatrices having encoding parameters as coefficients.

For example, for two input matrices A and B, the central node N0 transmits encoding matrices Ã_{w}, \tilde{B}_{w} obtained by encoding the input matrices A and B to an computing node Nw. For example, the central node N0 transmits the encoding matrices Ã₁, \tilde{B}₁ to the computing node N1.

The plurality of computing nodes N1, N2, N3, and N4 each execute multiplication of encoding matrices, and transmit a result thereof to the central node N0. The central node N0 receives an encoding matrix multiplication result from at least some of the plurality of computing nodes N1, N2, N3, and N4.

The central node N0 restores a matrix multiplication result for the input matrices, that is, an original operation result from the received encoding matrix multiplication result.

In an example, the central node N0 may restore the original operation result from received encoding matrix multiplication using a frame for decoding input matrices.

FIG. 2 is a block diagram of a distributed matrix multiplication operation apparatus according to an embodiment.

The distributed matrix multiplication operation apparatus 100 according to the embodiment may include a processor 110 and a memory 120.

The distributed matrix multiplication operation apparatus 100 according to the embodiment includes the processor 110 and the memory 120.

The processor 110 is a type of central processing unit, and may execute one or more commands stored in the memory 120 to execute the distributed matrix multiplication operation method according to the embodiment. The processor 110 may include all types of devices capable of processing operations on data.

The processor 110 may refer to, for example, a data processing device embedded in hardware having a physically structured circuit to perform a function expressed as a code or an instruction included in a program. As an example of the data processing device embedded in the hardware as described above, it is possible to include processing units such as a microprocessor, a central processing unit (CPU), a processor core, a multiprocessor, an application-specific integrated circuit (ASIC), a field programmable gate array (FPGA), and a graphics processing unit (GPU). However, the present invention is not limited thereto.

The processor 110 may include one or more processors. For example, the processor 110 may include the CPU and the GPU. For example, the processor 110 may include a plurality of GPUs. The processor 110 may include at least one core.

The memory 120 may store an instruction for executing a parallel LU decomposition provision method according to an embodiment by the distributed matrix multiplication operation apparatus 100. The memory 120 may store an executable program that generates and executes one or more instructions for implementing the distributed matrix multiplication operation method according to the embodiment.

The processor 110 may execute the distributed matrix multiplication operation method according to the embodiment based on programs and commands stored in the memory 120.

The memory 120 may include an internal memory and/or an external memory, and may include a volatile memory such as a DRAM, an SRAM, or an SDRAM, a non-volatile memory such as a one-time programmable ROM (OTPROM), a PROM, an EPROM, an EEPROM, a mask ROM, a flash ROM, a NAND flash memory, or a NOR flash memory, a flash drive such as an SSD, a compact flash (CF) card, an SD card, a Micro-SD card, a Mini-SD card, an Xd card, or a memory stick, or a storage device such as an HDD. The memory 120 may include, but is not limited to, magnetic storage media or flash storage media.

Additionally, the distributed matrix multiplication operation apparatus 100 may further include a communication unit 130.

The communication unit 130 provides a communication interface that provides a transmission/reception signal in the form of packet data between the distributed matrix multiplication operation apparatus 100 and an external device including an additional distributed matrix multiplication operation apparatus 100 using wired/wireless communication technology. In addition, the communication unit 130 may be a device including hardware and software necessary for transmitting and receiving a control signal or a data signal through wired/wireless connection with other network devices.

The communication unit 130 may provide a high-speed communication interface for a computer cluster including a plurality of computing nodes 100. For example, the communication unit 130 may provide a message passing interface (MPI), a parallel virtual machine (PVM), MPICH, Open MPI, etc.

The distributed matrix multiplication operation apparatus 100 executes the distributed matrix multiplication operation method according to the embodiment. To this end, at least one command stored in the memory 120 may be configured to cause the processor 110 to generate a plurality of first submatrices obtained by dividing a first input matrix and a plurality of second submatrices obtained by dividing a second input matrix, encode each of the plurality of first submatrices and the plurality of second submatrices to generate a first encoding matrix and a second encoding matrix for each computing node of a plurality of computing nodes, distribute the first encoding matrix and the second encoding matrix for each computing node to each computing node, acquire at least one encoding matrix multiplication result based on the first encoding matrix and the second encoding matrix for each computing node from at least some of the plurality of computing nodes, and restore a matrix multiplication result for the first input matrix and the second input matrix based on the at least one encoding matrix multiplication result when executed by the processor 110.

At least one command stored in the memory 120 may be configured to cause the processor 110 to generate a first encoding matrix of each computing node based on a first encoding frame of each computing node and a plurality of first submatrices and generate a second encoding matrix of each computing node based on a second encoding frame of each computing node and a plurality of second submatrices in order to generate the first encoding matrix and the second encoding matrix when executed by the processor 110.

In an example, the first encoding frame may be configured as an equiangular tight frame of a first matrix space according to a division order of the first input matrix, and the second encoding frame may be configured as an equiangular tight frame of a second matrix space according to a division order of the second input matrix.

In an example, the first encoding frame may be configured as a matrix having a first encoding parameter corresponding to each first submatrix as a matrix component, and the second encoding frame may be configured as a matrix having a second encoding parameter corresponding to each second submatrix as a matrix component.

At least one command stored in the memory 120 may be configured to cause the processor 110 to generate a first encoding matrix by a linear function based on a first encoding parameter and a first submatrix corresponding to the first encoding parameter, and generate a second encoding matrix by a linear function based on a second encoding parameter and a second submatrix corresponding to the second encoding parameter in order to generate the first encoding matrix and the second encoding matrix for each computing node when executed by the processor 110.

At least one command stored in the memory 120 may be configured to cause the processor 110 to determine a first decoding frame for the first input matrix and a second decoding frame for the second input matrix based on a node index set of an computing node calculating the encoding matrix multiplication result, and determine an original matrix multiplication result based on the first decoding frame, the second decoding frame, and the encoding matrix multiplication result in order to restore the original matrix multiplication result when executed by the processor 110.

At least one command stored in the memory 120 may be configured to cause the processor 110 to generate a node index set of an computing node calculating the encoding matrix multiplication result, determine a first frame index set and a second frame index set allowing a direct product of the first frame index set and the second frame index set to become a subset of the node index set, and determine the first decoding frame and the second decoding frame based on the first frame index set and the second frame index set in order to determine the first decoding frame for the first input matrix and the second decoding frame for the second input matrix when executed by the processor 110.

Before examining the distributed matrix multiplication operation method according to the embodiment, the present invention will be schematically described.

For example, a distributed matrix multiplication operation system according to an embodiment may be an edge processing system for multiplying two matrices A∈ [symbol] ^{s×t} and B∈ [symbol] ^{t×μ} to provide an operation result C=A^{T}B∈ [symbol] ^{s×μ} in the distributed matrix multiplication operation apparatus 100, that is, a single central unit (or node).

To this end, the distributed matrix multiplication operation apparatus 100, that is, the central node, encodes each of submatrices obtained by dividing matrices AT and B, causes N computing nodes (that is, edge nodes) to perform divided operations, and then receives results to perform restoration.

More specifically, the distributed matrix multiplication operation apparatus 100 divides the entire matrices AT and B into the pm submatrices and pn submatrices, respectively, as follows.

$${A}^{T} = [ \begin{matrix}{A}_{11}^{T} & … & {A}_{p 1}^{T} \\ ⋮ & ⋱ & ⋮ \\ {A}_{1 m}^{T} & … & {A}_{pm}^{T}\end{matrix} ] , B = [ \begin{matrix}{B}_{11} & … & {B}_{p 1} \\ ⋮ & ⋱ & ⋮ \\ {B}_{1 n} & … & {B}_{pn}\end{matrix} ] \qquad [ Equation 1 ]$$

$$Here ,$$

$${A}_{{i}_{1} j}^{T} ∈ {ℂ}^{s / p \times t / m} , {B}_{{i}_{2} k} ∈ {ℂ}^{s / p \times u / n} , {i}_{1} , {i}_{2} ∈ \{ 1 , … , p \} , j ∈ \{ 1 , … , m \} , k ∈ \{ 1 , … , n \}$$

This corresponds to step (S1) referring to FIG. 3.

Next, the distributed matrix multiplication operation apparatus 100 encodes submatrices.

$$\\ \begin{matrix}{\tilde{A}}_{w} = {\sum }_{{i}_{1} = 1}^{p} {\sum }_{j = 1}^{m} {a}_{{w}_{{i}_{1} j}} {A}_{{i}_{1} j}^{{}_{} T} , {\tilde{B}}_{w} = {\sum }_{{i}_{2} = 1}^{p} {\sum }_{k = 1}^{n} {b}_{{w}_{{i}_{2} k}} {B}_{{i}_{2} k} & [ Equation 2 ]\end{matrix}$$

Here, a_{ωi}_{₁}ⱼ, b_{ωi}_{₂}ₖ∈ [symbol] denote encoding parameters, respectively, differ for each computing node, and are determined by the distributed matrix multiplication operation apparatus 100 so that an original result C can be effectively restored, which will be described later in step (S2) with reference to FIG. 3.

Subsequently, the distributed matrix multiplication operation apparatus 100 transmits Ã_{ω}, \tilde{B}_{ω} to an ωth computing node (ω being a natural number less than or equal to N), which will be described later in step (S3) with reference to FIG. 3.

Each computing node multiplies submatrices received from the distributed matrix multiplication operation apparatus 100. That is, the ωth computing node multiplies Ã_{ω}, \tilde{B}_{ω}.

The distributed matrix multiplication operation apparatus 100 receives an operation result C_{ω} of an computing node from N′<N computing nodes, which will be described later in step (S4) with reference to FIG. 3.

The distributed matrix multiplication operation apparatus 100 restores an original result A^{T}B according to the following steps. An index set of computing nodes from which the distributed matrix multiplication operation apparatus 100 receives the operation result C_{ω} is denoted by I={W₁, . . . . W_{N′}}.

A vector obtained by connecting components of an ith row and a jth column of Cᵢ (concatenated version) is denoted by \tilde{C}ᵢⱼ. That is, the vector is expressed by the following equation.

$$\\ \begin{matrix}{\tilde{C}}_{ij} = {[ {( {C}_{{w}_{1}} )}_{ij} … {( {C}_{{w}_{N}} )}_{ij} ]}^{T} & [ Equation 3 ]\end{matrix}$$

Here, (·)ᵢⱼ denotes components of an ith row and a jth column of the corresponding matrix.

The form of Aᵢⱼ^{T}Bₖₗ, which is a product of submatrices to be calculated by each computing node, is defined as the following column vector.

$$\\ \begin{matrix}{D}_{ij} = {[ {( {A}_{11}^{{}_{} T} {B}_{11} )}_{ij} … {( {A}_{pm}^{{}_{} T} {B}_{pm} )}_{ij} ]}^{T} & [ Equation 4 ]\end{matrix}$$

Since the distributed matrix multiplication operation apparatus 100 is aware of an encoding process and an encoding parameter thereof, an equation for a relationship between \tilde{C}ᵢⱼ and Dᵢⱼ is as follows.

$$\\ \begin{matrix}{\tilde{C}}_{ij} = {PD}_{ij} & [ Equation 5 ]\end{matrix}$$

Therefore, the distributed matrix multiplication operation apparatus 100 may multiply P-1 (that is, an inverse matrix of P) by \tilde{C}ᵢⱼ to obtain Dᵢⱼ, that is, Aᵢⱼ^{T}Bₖₗ, and obtain a matrix multiplication result A^{T}B, which has been originally attempted to be obtained. Such a restoration process will be examined in step (S5) with reference to FIG. 3.

Meanwhile, in the embodiment, a distributed matrix multiplication problem is reconfigured in the form of a tensor product. That is, in order to lower the complexity of the matrix product, each of the first input matrix AT and the second input matrix B may be reconfigured in the form of a tensor product of submatrices and a base thereof.

$$\\ \begin{matrix}{A}^{{}_{} T} = {\sum }_{{e}_{1} = 1}^{{n}_{A}} {E}_{{e}_{1}}^{{}_{} A} ⊗ {u}_{{e}_{1}} ( A ) , B = {\sum }_{{e}_{2} = 1}^{{n}_{B}} {E}_{{e}_{2}}^{{}_{} B} ⊗ {u}_{{e}_{2}} ( B ) & [ Equation 6 ]\end{matrix}$$

Here, S_{A}={E₁^{A}, . . . , Eₙ_{_{A}}^{A}} and S_{B}={E₁^{B}, . . . , Eₙ_{_{B}}^{B}} are frames included in an m×p-vector space and a p×n-vector space, respectively, and the frames each refer to a set structure relieving a linear independent condition of a base. S_{A}, S_{B} correspond to first and second decoding frames, respectively, in the distributed matrix multiplication operation method according to the embodiment.

nA and nB denote the numbers of elements of first and second decoding frame sets S_{A}, S_{B}, respectively. In addition, μₑ_{₁}(A): [symbol] ^{t×s}→ [symbol] ^{t/p×s/m} and νₑ_{₁}(B): [symbol] ^{t×μ}→ [symbol] ^{t/p×μ/n} are linear functions (linear mapping) expressed as linear sums of submatrices A₁₁^{T}, . . . , Aₚₘ^{T} and, B₁₁^{T}, . . . , Bₚₙ^{T}, respectively, as follows.

$$\\ \begin{matrix}{u}_{{e}_{1}} ( A ) := {\sum }_{{i}_{1} = 1}^{p} {\sum }_{j = 1}^{m} {a}_{{e}_{1} ij}^{{}_{} ′} {A}_{ij}^{{}_{} T} , {v}_{{e}_{2}} ( B ) := {\sum }_{{i}_{2} = 1}^{p} {\sum }_{j = 1}^{n} {b}_{{e}_{2} ij}^{{}_{} ′} {B}_{ij} & [ Equation 7 ]\end{matrix}$$

Sets of matrices having values of coefficients aₑ_{₁}ᵢⱼ, bₑ_{₁}ᵢⱼ of the linear functions μₑ_{₁}(A) and νₑ_{₂}(B) as ith rows and jth columns are expressed as S′_{A}, S′_{B}, respectively.

The present invention proposes a method of determining values of the matrix sets S_{A}, D_{B} and the coefficients aₑ_{₁}ᵢⱼ, bₑ_{₂}ᵢⱼ of the linear functions μₑ_{₁}(A) and νₑ_{₂}(B). To this end, the corresponding values are defined as transition matrices as follows.

$$\\ \begin{matrix}{P}_{A} = [ \begin{matrix}{( {E}_{1}^{{}_{} A} )}_{11} & ⋯ & {( {E}_{{n}_{A}}^{{}_{} A} )}_{11} \\ ⋮ & ⋱ & ⋮ \\ {( {E}_{1}^{{}_{} A} )}_{pm} & ⋯ & {( {E}_{{n}_{A}}^{{}_{} A} )}_{pm}\end{matrix} ] , {Q}_{B} = [ \begin{matrix}{( {E}_{1}^{{}_{} B} )}_{11} & ⋯ & {( {E}_{{n}_{A}}^{{}_{} B} )}_{11} \\ ⋮ & ⋱ & ⋮ \\ {( {E}_{1}^{{}_{} B} )}_{pn} & ⋯ & {( {E}_{{n}_{A}}^{{}_{} B} )}_{pn}\end{matrix} ] & [ Equation 8 ]\end{matrix}$$

$$\\ {U}_{A} = [ \begin{matrix}{a}_{111}^{{}_{} ′} & ⋯ & {a}_{1 pm}^{{}_{} ′} \\ ⋮ & ⋱ & ⋮ \\ {a}_{{n}_{A 11}}^{{}_{} ′} & ⋯ & {a}_{{n}_{A} pm}^{{}_{} ′}\end{matrix} ] , {V}_{B} = [ \begin{matrix}{b}_{111}^{{}_{} ′} & ⋯ & {b}_{1 pn}^{{}_{} ′} \\ ⋮ & ⋱ & ⋮ \\ {b}_{{n}_{B} 11}^{{}_{} ′} & ⋯ & {b}_{{n}_{B} pn}^{{}_{} ′}\end{matrix} ]$$

Under such conditions, the distributed matrix multiplication operation method according to the embodiment configures encoding frame matrix sets S′_{A}, S′_{B} by the processor 110. At this time, the encoding frame matrix sets S′_{A}, S′_{B} are determined so that the number of cases of encoding frames, that is, μₑ_{₁}(A) and νₑ_{₂}(B) is smaller than the total number N of computing nodes (that is, n_{A}n_{B}<N).

Based thereon, the first input matrix AT and the second input matrix B to be subjected to multiplication are encoded according to the following Equation 9.

$$\\ \begin{matrix}{\tilde{A}}_{{n}_{B} ( {e}_{1} - 1 ) + {e}_{2}} = {u}_{{e}_{1}} ( A ) & [ Equation 9 ]\end{matrix}$$

$$\\ {\tilde{B}}_{{n}_{B} ( {e}_{1} - 1 ) + {e}_{2}} = {v}_{{e}_{2}} ( B )$$

Encoding matrices Ã_{ω} and \tilde{B}_{ω} w generated in this way are transmitted to a node ω. Here, ω is an index for searching all matrix elements of a given matrix one by one in lexicographic order based on a row index e1 and a column index e2 of the given matrix, and ω=nB(e1−1)+e2.

$$\\ \begin{matrix}{\tilde{A}}_{{n}_{B} ( {e}_{1} - 1 ) + {e}_{2}} = {u}_{{e}_{1}} ( A ) & [ Equation 10 ]\end{matrix}$$

$$\\ {\tilde{B}}_{{n}_{B} ( {e}_{1} - 1 ) + {e}_{2}} = {v}_{{e}_{2}} ( B )$$

Each computing node performs matrix multiplication on received encoding matrices for each node. That is, the ωth computing node performs multiplication Ã_{ω}\tilde{B}_{ω}.

The central node receives a partial product result C_{ω} from an computing node at a given time period. Before expressing an computing node index set for the received result C_{ω}, indices (e1, e2) of all possible different frame matrix sets are expressed as follows.

$$\\ \begin{matrix}I = \{ ( {e}_{1} , {e}_{2} ) \vert {e}_{1} = 1 , … , {n}_{A} , {e}_{2} = 1 , … , {n}_{B} \} & [ Equation 11 ]\end{matrix}$$

An computing node index set I′ for the received result C_{ω} may be expressed as a subset of I as follows.

$$\\ \begin{matrix}\{ {n}_{B} ( {e}_{1} - 1 ) + {e}_{2} \vert ( {e}_{1} , {e}_{2} ) ∈ {I}^{{}_{} ′} \} & [ Equation 12 ]\end{matrix}$$

Frame matrices S_{A}, S_{B} according to an computing node index set corresponding to the received result C_{ω} are flexibly configured. That is, in order to restore the original result, among subsets of the computing node index set corresponding to the previously received result C_{ω}, Ĩ expressed as a direct product of I₁⊂{1, . . . , n_{A}} and I₂⊂{1, . . . , n_{B}} is found. Ĩ is an index set satisfying the following equation and is a subset of I′.

$$\\ \begin{matrix}\tilde{I} = \{ {n}_{B} ( {e}_{1} - 1 ) + {e}_{2} \vert ( {e}_{1} , {e}_{2} ) ∈ {I}_{1} \times {I}_{2} \} ⊂ {I}^{{}_{} ′} & [ Equation 13 ]\end{matrix}$$

The frame matrices S_{A}, S_{B} are configured by utilizing Ĩ and S′_{A}S′_{B}.

Subsequently, the original operation result C (that is, A^{T}B) of the matrix multiplication is restored using the frame matrices S_{A}, S_{B}. Finally, the original operation result is restored by the following equation at the central node through the frame matrices S_{A}, S_{B} obtained above.

$$\\ \begin{matrix}C = {\sum }_{{e}_{1} ∈ {I}_{1}} {\sum }_{{e}_{2} ∈ {I}_{2}} ( {E}_{{e}_{1}}^{{}_{} A} {E}_{{e}_{2}}^{{}_{} B} ⊗ {u}_{{e}_{1}} ( A ) {v}_{{e}_{2}} ( B ) ) & [ Equation 14 ]\end{matrix}$$

Meanwhile, in the present invention, an encoding frame and a decoding frame for performing the distributed matrix multiplication operation according to the embodiment are designed. That is, in the present invention, the encoding frame and the decoding frame are configured in the following two steps.

First, an optimal decoding frame is determined according to a given encoding frame as follows.

Transition matrices P_{A} and Q_{B} corresponding to optimal decoding frames S_{A}, S_{B} minimizing an operation error rate for transition matrices U_{A} and V_{B} corresponding to the operation result C_{ω} and the encoding frames S′_{A}, S′_{B} from the given index set Ĩ={n_{B}(e₁−1)+e₂|(e₁, e₂)∈I₁×I₂}⊂I′ are determined according to the following equation.

$$[ Equation 15 ]$$

$$\\ \begin{matrix}( {P}_{A}^{{}_{} ★} , {Q}_{B}^{{}_{} ★} ) = {arg}_{( {P}_{A} , {Q}_{B} )} {‖ {A}^{{}_{} T} B - C ‖}_{F} \\ = {arg}_{( {P}_{A} , {Q}_{B} )} {‖ {A}^{{}_{} T} B - {\sum }_{{e}_{1} ∈ {S}_{1}} {\sum }_{{e}_{2} ∈ {S}_{2}} ( {E}_{{e}_{1}}^{{}_{} A} {E}_{{e}_{2}}^{{}_{} B} ⊗ {u}_{{e}_{1}} ( A ) {v}_{{e}_{2}} ( B ) ) ‖}_{F}\end{matrix}$$

Finally, the distributed matrix multiplication operation method according to the embodiment may generate the encoding frames S′_{A}, S′_{B} based on an equiangular tight frame. When the input matrices A^{T} and B are encoded using such encoding frames S′_{A}, S′_{B}, the encoding matrices Ã_{w} and \tilde{B}_{w} are equally distributed in a vector space of the input matrices A^{T} and B.

That is, the first encoding matrix Ã_{w} of the first input matrix AT and the second encoding matrix \tilde{B}_{w} of the second input matrix B are equally distributed in the m×p-vector space and the p×n-vector space, and thus the original matrix C (that is, A^{T}B) may be restored without bias for arbitrary first and second input matrices AT and B.

Examples of the equiangular tight frame include a Kirkman frame, a Steiner frame, etc. in addition to a Hadamard frame and a harmonic frame, and the distributed matrix multiplication operation method according to the embodiment may use various types of equiangular tight frames without being limited thereto.

Hereinafter, the distributed matrix multiplication operation method by the distributed matrix multiplication operation apparatus 100 according to the embodiment will be described with reference to the drawings.

FIG. 3 is a flowchart of the distributed matrix multiplication operation method according to the embodiment.

The distributed matrix multiplication operation method according to the embodiment includes a step S1 of generating a plurality of first submatrices Aᵢ_{₁}ⱼ^{T} obtained by dividing a first input matrix AT and a plurality of second submatrices Bᵢ_{₂}ₖ obtained by dividing a second input matrix B, a step S2 of encoding each of the plurality of first submatrices Aᵢ_{₁}ⱼ^{T} and the plurality of second submatrices Bᵢ_{₂}ₖ to generate a first encoding matrix Ã_{w} and a second encoding matrix \tilde{D}_{w} for each computing node of a plurality of computing nodes, a step S3 of distributing the first encoding matrix Ã_{w} and the second encoding matrix \tilde{B}_{w} for each computing node to each computing node, a step S4 of acquiring at least one encoding matrix multiplication result C_{ω} based on the first encoding matrix Ã_{w} and the second encoding matrix \tilde{B}_{w} for each computing node from at least some of the plurality of computing nodes, and a step S5 of restoring a matrix multiplication result A^{T}B for the first input matrix AT and the second input matrix B based on the at least one encoding matrix multiplication result C_{ω}.

In step S1, the processor 110 executes a command stored in the memory 120 to generate a plurality of first submatrices Aᵢ_{₁}ⱼ^{T} obtained by dividing the first input matrix AT and the plurality of second submatrices Tᵢ_{₂}ₖ obtained by dividing the second input matrix B.

In step S1, by referring to Equation 1, the processor 110 divides the first input matrix AT into pm first submatrices Aᵢ_{₁}ⱼ^{T} and divides the second input matrix B into pn second submatrices Rᵢ_{₂}ₖ (p, m, and n each being a natural number).

In step S2, the processor 110 encodes each of the plurality of first submatrices Aᵢ_{₁}ⱼ^{T} and the plurality of second submatrices Bᵢ_{₂}ₖ to generate a first encoding matrix Ã_{w} and a second encoding matrix \tilde{B}_{w} for each computing node of a plurality of computing nodes.

Step S2 may include a step of generating a first encoding matrix Ã_{w} of each computing node based on a first encoding frame of each computing node and a plurality of first submatrices Aᵢ_{₁}ⱼ^{T}, and a step of generating a second encoding matrix \tilde{B}₂ of each computing node based on a second encoding frame of each computing node and a plurality of second submatrices Bᵢ_{₂}ₖ.

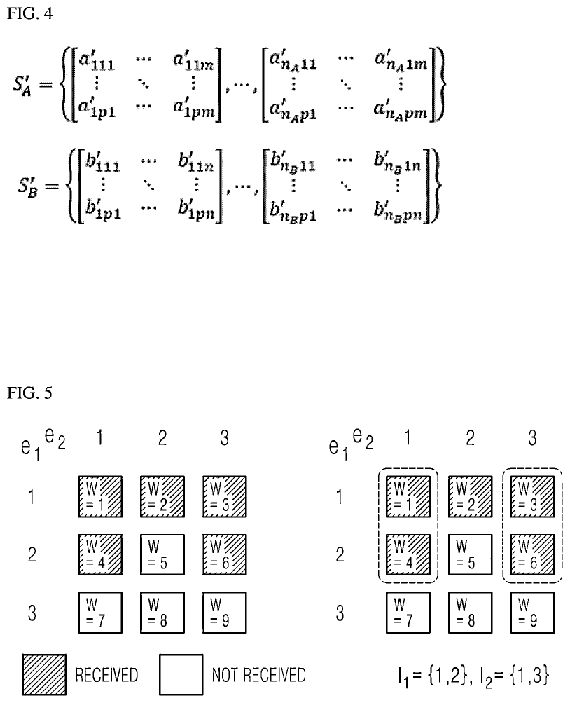

For example, the first encoding frame is determined as one of elements of a first encoding frame set S′_{A}. For example, the second encoding frame is determined as one of elements of a second encoding frame set (S′_{B}. The encoding frame sets and the encoding frames will be described later with reference to FIG. 4.

In an example, the first encoding frame may be configured as an equiangular tight frame of a first vector space according to a division order (for example, p×n) of the first input matrix AT, and the second encoding frame may be configured as an equiangular tight frame of a second vector space according to a division order (for example, p×m) of the second input matrix B.

In an example, the first encoding frame may be configured as a matrix having a first encoding parameter a′ₑ_{₁}ᵢⱼ corresponding to each first submatrix Aᵢⱼ^{T} as a matrix component, and the second encoding frame may be configured as a matrix having a second encoding parameter b′ₑ_{₂}ᵢⱼ corresponding to each second submatrix Bᵢⱼ as a matrix component.

In an example, step S2 may include a step of generating, by the processor 110, a first encoding matrix Ã_{w} by a linear function μₑ_{₁} based on the first encoding parameter a′ₑ_{₁}ᵢⱼ and the first submatrix Aᵢⱼ^{T} corresponding to the first encoding parameter a′ₑ_{₁}ᵢⱼ, and a step of generating a second encoding matrix \tilde{B}_{w} by a linear function νₑ_{₂} based on the second encoding parameter b′ₑ_{₂}ᵢⱼ and the second submatrix Bᵢⱼ corresponding to the second encoding parameter b′ₑ_{₂}ᵢⱼ, which is performed with reference to Equation 7 to Equation 9 and the above-description.

In step S3, the processor 110 distributes the first encoding matrix Ã_{w} and the second encoding matrix \tilde{B}_{w} for each computing node generated in step S2 to each computing node.

In step S3, the processor 110 transmits the first encoding matrix Ã_{w} and the second encoding matrix \tilde{B}_{w} to a wth computing node using an index according to lexicographic order based on description related to Equation 10 described above through the communication unit 130.

In step S4, the processor 110 acquires at least one encoding matrix multiplication result C_{ω} based on the first encoding matrix Ã_{w} and the second encoding matrix \tilde{B}_{w} for each computing node from at least some of the plurality of computing nodes.

For example, the processor 110 may transmit the first encoding matrix Ã_{w} and the second encoding matrix \tilde{B}_{w} for each computing node to all N computing nodes, and acquire the at least one encoding matrix multiplication result C_{ω} from M computing nodes. Here, M is a natural number less than or equal to N.

In step S5, the processor 110 restores the matrix multiplication result A^{T}B for the first input matrix AT and the second input matrix B based on the at least one encoding matrix multiplication result C_{ω}.

Step S5 may include a step of determining, by the processor 110, a first decoding frame Eₑ_{₁}^{A} for the first input matrix AT and a second decoding frame Eₑ_{₁}^{B} for the second input matrix B based on a node index set I′ of an computing node calculating the encoding matrix multiplication result C_{ω}, and a step of determining, by the processor 110, a matrix multiplication result based on the first decoding frame, the second decoding frame, and the encoding matrix multiplication result C_{ω}.

The step of determining the first decoding frame Eₑ_{₁}^{A} for the first input matrix AT and the second decoding frame Eₑ_{₂}^{B} for the second input matrix of step S5 includes a step of generating, by the processor 110, a node index set I′ of an computing node calculating the encoding matrix multiplication result, a step of determining a first frame index set I1 and a second frame index set I2 allowing a direct product of the first frame index set I1 and the second frame index set I2 to become a subset of the node index set I′, and a step of determining a first decoding frame Eₑ_{₁}^{A} and a second decoding frame Eₑ_{₂}^{B} based on the first frame index set I1 and the second frame index set I2, which may be performed according to the above description in connection with Equations 11 to 14.

FIG. 4 illustrates an illustrative encoding frame set.

The first encoding frame set S′_{A} is a set including nA first encoding frame matrices as elements. Here, each of the first encoding frame matrices is a matrix having first encoding parameters a′ₑ_{₁}ᵢⱼ, the number of which is a division order of the first input matrix AT (for example, p×m), as matrix elements. Here, e1 denotes an index of a first encoding frame matrix included in the first encoding frame set S′_{A}.

For example, a first one of the first encoding frame matrices is a matrix having a first encoding parameter a′₁ᵢⱼ as a matrix element of an ith row and a jth column.

Likewise, the second encoding frame set S′_{B} is a set including nB second encoding frame matrices as elements. Here, each of the second encoding frame matrices is a matrix having second encoding parameters b′ₑ_{₂}ᵢⱼ, the number of which is a division order of the second input matrix B (for example, p×n), as matrix elements. Here, e2 denotes an index of a second encoding frame matrix included in the second encoding frame set S′_{B}.

For example, a first one of the second encoding frame matrices is a matrix having a second encoding parameter b′₁ᵢⱼ as a matrix element of an ith row and a jth column.

FIG. 5 is a diagram for illustratively describing a process in decoding for a distributed matrix multiplication operation according to an embodiment.

Here, e1 denotes a frame index of a first decoding frame set S_{A}, and e2 denotes a frame index of a second decoding frame set S_{B}.

For example, referring to FIG. 3, in step S4, it is presumed that an encoding matrix multiplication result is received from each of an computing node 1 (w=1), an computing node 2 (w=2), an computing node (w=3), an computing node (w=4), and an computing node (w=6).

In this case, Ĩ expressed as a direct product of I₁⊂{1, . . . , n_{A}} and I₂⊂{1, . . . , n_{B}} is found among subsets of an operation index set corresponding to the received result C_{ω} as described above in connection with Equation 13.

As a result, in the example illustrated in FIG. 5, since the encoding matrix multiplication result cannot be received from an computing node (w=5), the computing node (w=2) is excluded. That is, I1={1, 2}, I2={1, 3}, and Ĩ is determined as {1, 3, 4, 6}.

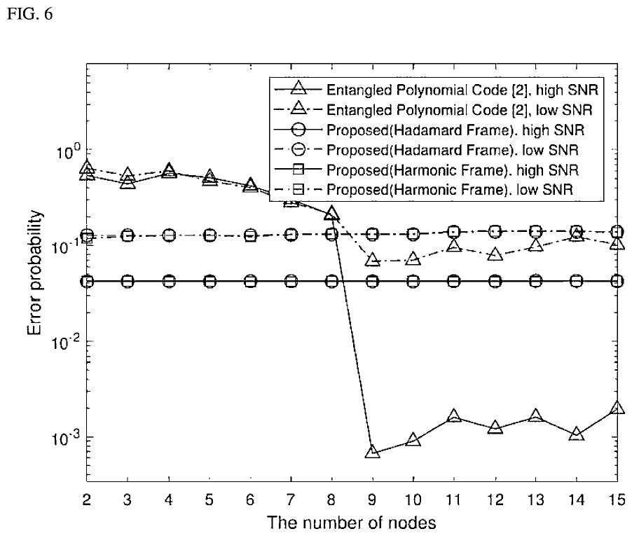

FIG. 6 is a graph illustrating an average error probability according to the number of nodes according to an embodiment.

In an example, by the method according to the embodiment, a ratio of an error of a restored operation matrix to a size of an original matrix may be determined as a normalized error of a restored matrix multiplication result as in the following equation.

$$\\ \begin{matrix}\frac{{‖ \hat{C} - C ‖}_{F}}{{‖ C ‖}_{F}} & [ Equation 16 ]\end{matrix}$$

Here, (·) denotes the Frobenius norm.

In FIG. 6, errors according to Equation 16 are compared for various techniques. A simulation environment is as follows.

Original matrices to be calculated are a 300×300-matrix A and a 300×300-matrix B having arbitrary values, and are divided into pm submatrices and pn submatrices, respectively. Matrices having the same size are multiplied in all simulations so that each computing node uses the same computing ability. A parameter for a degree of division is determined as p=m=n=2.

In addition, simulations are performed using the Hadamard frame and the harmonic frame among several types of equiangular tight frames.

As a simulation result, a normalized error is illustrated in the graph of FIG. 6.

In an environment where the number of nodes is not large, the existing technique has a probability between 0.1 and 1, whereas the distributed matrix multiplication operation method according to the embodiment shows a probability of 10-2 to 10-1. It can be seen that the performance is superior in the method according to the embodiment.

The present invention proposes a distributed matrix multiplication technique, which has a more complex structure than arithmetic operations, and is the basis for high-dimensional operations.

The method according to the embodiment may be utilized in terms of a function as a service (FaaS) in various companies such as Amazon, Microsoft, and Google providing cloud services. In addition, the method according to the embodiment is applicable to all applications of distributed computing and high intelligence applications such as big data analysis, augmented reality, tactile communication, etc., as well as all applications requiring high-dimensional computation with a large load.

The method according to the embodiment may solve performance degradation when a large load operation is performed in a single device, and improves the performance by distributing high-dimensional matrix multiplication while communicating with several computing nodes. In particular, a low error below a certain level is ensured in an environment having a small number of nodes.

According to an embodiment, an original matrix multiplication operation result may be restored with a partial encoding matrix multiplication operation result.

According to an embodiment, high-dimensional matrix multiplication operation performance is improved.

Effects of the present invention are not limited to those mentioned above, and other effects not mentioned herein will be clearly understood by those skilled in the art from the above description.

The method according to the embodiment of the present invention described above may be implemented as computer-readable code on a medium in which a program is recorded. The computer-readable medium includes all types of recording devices in which data readable by a computer system is stored. Examples of the computer-readable medium include a hard disk drive (HDD), a solid state drive (SSD), a silicon disk drive (SDD), a ROM, a RAM, a CD-ROM, a magnetic tape, a floppy disk, an optical data storage device, etc.

The above description of the embodiments of the present invention is for illustration, and it should be understood that those of ordinary skill in the art to which the present invention pertains may easily perform modification into other specific forms without changing the technical spirit or essential features of the present invention. Therefore, it should be understood that the embodiments described above are illustrative in all respects and not restrictive. For example, each component described as a single type may be implemented in a dispersed form, and likewise components described as distributed may be implemented in a combined form.

The scope of the present invention is indicated by the following claims rather than the above detailed description, and all changes or modifications derived from the meaning and scope of the claims and equivalents thereto should be construed as being included in the scope of the present invention.

1. A distributed matrix multiplication operation method comprising:
generating a plurality of first submatrices obtained by dividing a first input matrix and a plurality of second submatrices obtained by dividing a second input matrix;
generating a first encoding matrix and a second encoding matrix for each computing node of a plurality of computing nodes by encoding each of the plurality of first submatrices and the plurality of second submatrices;
distributing the first encoding matrix and the second encoding matrix for each computing node to each computing node;
acquiring at least one encoding matrix multiplication result based on the first encoding matrix and the second encoding matrix for each computing node from at least some of the plurality of computing nodes; and
restoring a matrix multiplication result for the first input matrix and the second input matrix based on the at least one encoding matrix multiplication result.

2. The distributed matrix multiplication operation method according to claim 1, wherein the generating of the first encoding matrix and the second encoding matrix for each computing node includes:
generating a first encoding matrix of each computing node based on a first encoding frame of each computing node and the plurality of first submatrices; and
generating a second encoding matrix of each computing node based on a second encoding frame of each computing node and the plurality of second submatrices.

3. The distributed matrix multiplication operation method according to claim 2, wherein:
the first encoding frame is an equiangular tight frame of a first vector space according to a division order of the first input matrix; and
the second encoding frame is an equiangular tight frame of a second vector space according to a division order of the second input matrix.

4. The distributed matrix multiplication operation method according to claim 2, wherein:
the first encoding frame is a matrix having a first encoding parameter corresponding to each of the first submatrices as a matrix component; and
the second encoding frame is a matrix having a second encoding parameter corresponding to each of the second submatrices as a matrix component.

5. The distributed matrix multiplication operation method according to claim 4, wherein the generating of the first encoding matrix and the second encoding matrix for each computing node includes:
generating the first encoding matrix by a linear function based on the first encoding parameter and a first submatrix corresponding to the first encoding parameter; and
generating the second encoding matrix by a linear function based on the second encoding parameter and a second submatrix corresponding to the second encoding parameter.

6. The distributed matrix multiplication operation method according to claim 1, wherein the restoring includes:
determining a first decoding frame for the first input matrix and a second decoding frame for the second input matrix based on a node index set of an computing node calculating the encoding matrix multiplication result; and
determining the matrix multiplication result based on the first decoding frame, the second decoding frame, and the encoding matrix multiplication result.

7. The distributed matrix multiplication operation method according to claim 6, wherein the determining of the first decoding frame for the first input matrix and the second decoding frame for the second input matrix includes:
generating a node index set of an computing node calculating the encoding matrix multiplication result;
determining a first frame index set and a second frame index set allowing a direct product of the first frame index set and the second frame index set to become a subset of the node index set; and
determining the first decoding frame and the second decoding frame based on the first frame index set and the second frame index set.

8. A distributed matrix multiplication operation apparatus comprising:
a memory configured to store at least one command; and
a processor,
wherein, when the at least one command is executed by the processor, the at least one command is configured to cause the processor to:
generate a plurality of first submatrices obtained by dividing a first input matrix and a plurality of second submatrices obtained by dividing a second input matrix;
generate a first encoding matrix and a second encoding matrix for each computing node of a plurality of computing nodes by encoding each of the plurality of first submatrices and the plurality of second submatrices;
distribute the first encoding matrix and the second encoding matrix for each computing node to each computing node;
acquire at least one encoding matrix multiplication result based on the first encoding matrix and the second encoding matrix for each computing node from at least some of the plurality of computing nodes; and
restore a matrix multiplication result for the first input matrix and the second input matrix based on the at least one encoding matrix multiplication result.

9. The distributed matrix multiplication operation apparatus according to claim 8, wherein, when the at least one command is executed by the processor, to generate a first encoding matrix and a second encoding matrix for each computing node, the at least one command is configured to cause the processor to:
generate a first encoding matrix of each computing node based on a first encoding frame of each computing node and the plurality of first submatrices; and
generate a second encoding matrix of each computing node based on a second encoding frame of each computing node and the plurality of second submatrices.

10. The distributed matrix multiplication operation apparatus according to claim 9, wherein:
the first encoding frame is an equiangular tight frame of a first vector space according to a division order of the first input matrix; and
the second encoding frame is an equiangular tight frame of a second vector space according to a division order of the second input matrix.

11. The distributed matrix multiplication operation apparatus according to claim 9, wherein:
the first encoding frame is a matrix having a first encoding parameter corresponding to each of the first submatrices as a matrix component; and
the second encoding frame is a matrix having a second encoding parameter corresponding to each of the second submatrices as a matrix component.

12. The distributed matrix multiplication operation apparatus according to claim 11, wherein, when the at least one command is executed by the processor, to generate a first encoding matrix and a second encoding matrix for each computing node, the at least one command is configured to cause the processor to:
generate the first encoding matrix by a linear function based on the first encoding parameter and a first submatrix corresponding to the first encoding parameter; and
generate the second encoding matrix by a linear function based on the second encoding parameter and a second submatrix corresponding to the second encoding parameter.

13. The distributed matrix multiplication operation apparatus according to claim 8, wherein, when the at least one command is executed by the processor, to restore the matrix multiplication result, the at least one command is configured to cause the processor to:
determine a first decoding frame for the first input matrix and a second decoding frame for the second input matrix based on a node index set of an computing node calculating the encoding matrix multiplication result; and
determine the matrix multiplication result based on the first decoding frame, the second decoding frame, and the encoding matrix multiplication result.

14. The distributed matrix multiplication operation apparatus according to claim 13, wherein, when the at least one command is executed by the processor, to determine a first decoding frame for the first input matrix and a second decoding frame for the second input matrix, the at least one command is configured to cause the processor to:
generate a node index set of an computing node calculating the encoding matrix multiplication result;
determine a first frame index set and a second frame index set allowing a direct product of the first frame index set and the second frame index set to become a subset of the node index set; and
determine the first decoding frame and the second decoding frame based on the first frame index set and the second frame index set.

15. A computer-readable non-transitory recording medium storing a computer program including at least one command for executing, by a processor, the distributed matrix multiplication operation method according to claim 1.

16. A computer-readable non-transitory recording medium storing a computer program including at least one command for executing, by a processor, the distributed matrix multiplication operation method according to claim 2.

17. A computer-readable non-transitory recording medium storing a computer program including at least one command for executing, by a processor, the distributed matrix multiplication operation method according to claim 3.

18. A computer-readable non-transitory recording medium storing a computer program including at least one command for executing, by a processor, the distributed matrix multiplication operation method according to claim 4.

19. A computer-readable non-transitory recording medium storing a computer program including at least one command for executing, by a processor, the distributed matrix multiplication operation method according to claim 5.

20. A computer-readable non-transitory recording medium storing a computer program including at least one command for executing, by a processor, the distributed matrix multiplication operation method according to claim 6.
